(19) United States
(12) Patent Application Publication
(10) Pub. No.: US 2023/0392270 A1
(43) Pub. Date: Dec. 7, 2023

(54) CATHODE CATALYST LAYER, ORGANIC HYDRIDE PRODUCING DEVICE, AND METHOD FOR PREPARING CATHODE CATALYST INK

(71) Applicant: ENEOS Corporation, Chiyoda-ku, Tokyo (JP)

(72) Inventors: Toru TAKAMURA, Chiyoda-ku, Tokyo (JP); Miyuki KANEZAWA, Chiyoda-ku, Tokyo (JP); Koji MATSUOKA, Chiyoda-ku, Tokyo (JP); Atsuo SONAI, Chiyoda-ku, Tokyo (JP)

(73) Assignee: ENEOS Corporation, Chiyoda-ku, Tokyo (JP)

(21) Appl. No.: 18/251,187

(22) PCT Filed: Oct. 29, 2021
(86) PCT No.: PCT/JP2021/039993

§ 371 Date: Apr. 28, 2023

(30) Foreign Application Priority Data
Oct. 30, 2020 (WO) PCT/JP2020/040877

(51) Int. Cl. C25B 11/081; C25B 9/19; C25B 11/055; C25B 11/089; C25B 11/054; C25B 3/03; C25B 3/25

(52) U.S. Cl. CPC C25B 11/081; C25B 9/19; C25B 11/055; C25B 11/089; C25B 11/054; C25B 3/03; C25B 3/25

(57) ABSTRACT

A cathode catalyst layer includes a cathode catalyst to hydrogenate a substance to be hydrogenated, a porous catalyst support supporting the cathode catalyst, and a non-porous body including an aggregate of arbitrary primary particles. A volume fraction of the non-porous body in the cathode catalyst layer is higher than 10 vol % with respect to the volume of the total solid content of the cathode catalyst layer.

### CROSS-REFERENCE TO RELATED APPLICATIONS

This application is based upon and claims the benefit of priority from International Patent Application No. PCT/JP2020/040877, filed on Oct. 30, 2020 and International Patent Application No. PCT/JP2021/039993, filed on Oct. 29, 2021, the entire content of each of which is incorporated herein by reference.

### BACKGROUND

### Field of the Invention

The present invention relates to a cathode catalyst layer, an organic hydride producing device, and a method for preparing a cathode catalyst ink.

### Description of the Related Art

In recent years, in order to suppress the carbon dioxide emission amount in the energy generation process, renewable energy is expected to be used, which is obtained by solar light, wind power, hydraulic power, geothermal power generation, and the like. As an example, a system for generating hydrogen by performing water electrolysis using power derived from renewable energy has been devised. In addition, an organic hydride system has attracted attention as an energy carrier for large-scale transportation and storage of hydrogen derived from renewable energy.

Regarding a technique for producing an organic hydride, a conventional organic hydride producing device including an oxidation electrode for generating protons from water and a reduction electrode for hydrogenating an organic compound having an unsaturated bond is known (see, for example, Patent Literature 1). In this organic hydride producing device, a current flows between the oxidation electrode and the reduction electrode while water is supplied to the oxidation electrode, and a substance to be hydrogenated is supplied to the reduction electrode, so that hydrogen is added to the substance to be hydrogenated to obtain an organic hydride.
Patent Literature 1: WO2012/091128A

As a result of intensive studies on the above-described technique for producing an organic hydride, the present inventors have recognized that there is room for improvement in the Faraday efficiency (current efficiency) of the organic hydride producing device in the conventional technique.

### SUMMARY OF THE INVENTION

The present invention has been made in view of such a situation, and an object of the present invention is to provide a technique for improving the Faraday efficiency of an organic hydride producing device.

An aspect of the present invention is a cathode catalyst layer that hydrogenates a substance to be hydrogenated with a proton to generate an organic hydride. The cathode catalyst layer includes a cathode catalyst to hydrogenate the substance to be hydrogenated, a porous catalyst support supporting the cathode catalyst, and a non-porous body including an aggregate of arbitrary primary particles. A volume fraction of the non-porous body in the cathode catalyst layer is higher than 10 vol % with respect to the volume of the total solid content of the cathode catalyst layer.

Another aspect of the present invention is an organic hydride producing device. This device includes an electrolyte membrane having a first surface and a second surface facing away from each other and transporting a proton, a cathode provided on the first surface side of the electrolyte membrane and having the cathode catalyst layer of the above aspect, and an anode provided on the second surface side of the electrolyte membrane and oxidizing water to generate a proton.

Another aspect of the present invention is a method for preparing a cathode catalyst ink used in a cathode catalyst layer that hydrogenates a substance to be hydrogenated with a proton to generate an organic hydride. This method includes preparing a first solution by mixing a cathode catalyst, a porous catalyst support for supporting the cathode catalyst, and a solvent, preparing a second solution by adding to the first solution a dispersion of arbitrary primary particles, the amount of the dispersion being set so that a volume fraction of a non-porous body in the cathode catalyst layer is higher than 10 vol % with respect to the volume of the total solid content of the cathode catalyst layer, and forming the non-porous body including an aggregate of the primary particles by aggregating the primary particles in the second solution.

Any combinations of the above components and conversion of the expressions in the present disclosure between methods, devices, systems, and the like are also effective as aspects of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view of an organic hydride producing device according to an embodiment.

FIG. 2A is a SEM image of a surface of a cathode catalyst layer according to Example 1. FIG. 2B is a SEM image of a cross-section of the cathode catalyst layer according to Example 1.

FIG. 3 is a SEM image of a surface of a cathode catalyst layer according to Comparative Example 1.

FIG. 4A is a SEM image of a surface of a cathode catalyst layer according to Comparative Example 2. FIG. 4B is a SEM image of a cross-section of the cathode catalyst layer according to Comparative Example 2.

FIG. 5A is a SEM image of a surface of a cathode catalyst layer according to Comparative Example 3. FIG. 5B is a SEM image of a cross-section of the cathode catalyst layer according to Comparative Example 3.

FIG. 6 is a diagram showing the correlation between a toluene concentration in a catholyte and Faraday efficiency of an organic hydride producing device.

FIG. 7 is a diagram showing properties of cathode catalyst layers and performance of organic hydride producing devices in Test Examples 1 to 23.

### DETAILED DESCRIPTION OF THE INVENTION

Hereinafter, the present invention will be described based on preferred embodiments with reference to the drawings. The embodiments are illustrative rather than limiting the invention, and not all features described in the embodiments and combinations thereof are necessarily essential to the invention. The same or equivalent components, members, and processes illustrated in the drawings are denoted by the same reference numerals, and redundant description will be omitted as appropriate.

In addition, the scale and shape of each part illustrated in each drawing are set for convenience in order to facilitate the description, and are not to be limitedly interpreted unless otherwise specified. Furthermore, when the terms “first”, “second”, and the like are used in the present specification or claims, the terms do not represent any order or importance, but are used to distinguish one configuration from another configuration. In addition, in each drawing, some of members that are not important for describing the embodiments are omitted.

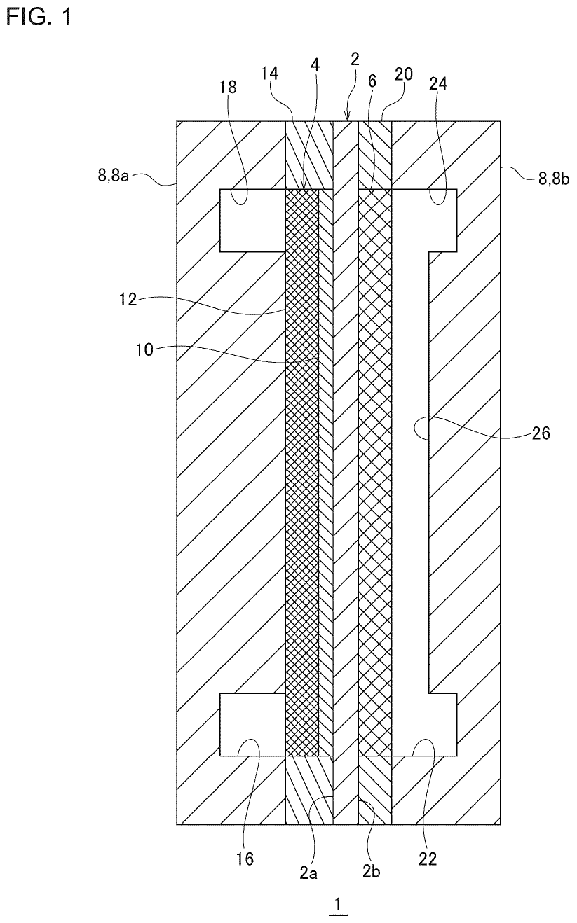

FIG. 1 is a cross-sectional view of an organic hydride producing device 1 according to an embodiment. In FIG. 1, the shape of each part is illustrated in a simplified manner. The organic hydride producing device 1 is an electrolytic cell (electrolytic bath) for hydrogenating a substance to be hydrogenated by an electrochemical reduction reaction, and includes an electrolyte membrane 2, a cathode 4, an anode 6, and a pair of end plates 8 as main components. Each of the electrolyte membrane 2, the cathode 4, the anode 6, and the pair of end plates 8 has a roughly flat or thin film-like shape.

The electrolyte membrane 2 is a membrane that is disposed between the cathode 4 and the anode 6 and transports protons from the anode 6 side to the cathode 4 side. The electrolyte membrane 2 has a first surface 2a and a second surface 2b facing away from each other. The first surface 2a faces the cathode 4, and the second surface 2b faces the anode 6. The electrolyte membrane 2 is composed of, for example, a solid polymer electrolyte membrane having proton conductivity. The solid polymer electrolyte membrane is not particularly limited as long as it is a proton-conducting material, and examples thereof include a fluorine-based ion exchange membrane having a sulfonic acid group such as Nafion (registered trademark).

The electrolyte membrane 2 selectively conducts protons while suppressing mixing and diffusion of substances between the cathode 4 and the anode 6. The thickness of the electrolyte membrane 2 is not particularly limited, and is, for example, 5 μm to 300 μm. By setting the thickness of the electrolyte membrane 2 to 5 μm or greater, a desired strength of the electrolyte membrane 2 can be more reliably obtained. Furthermore, by setting the thickness of the electrolyte membrane 2 to 300 μm or less, it is possible to inhibit ion transport resistance from becoming excessively large. The electrolyte membrane 2 may contain an arbitrary reinforcing material. When the electrolyte membrane 2 contains a reinforcing material, swelling of the electrolyte can be suppressed, thus suppressing a decrease in the strength of the electrolyte membrane 2.

The cathode 4 (negative electrode) is provided on the first surface 2a side of the electrolyte membrane 2. The cathode 4 of the present embodiment includes a cathode catalyst layer 10 and a cathode diffusion layer 12. The cathode catalyst layer 10 is disposed closer to the electrolyte membrane 2 than the cathode diffusion layer 12 is. The cathode catalyst layer 10 of the present embodiment is in contact with the first surface 2a of the electrolyte membrane 2. The cathode catalyst layer 10 hydrogenates a substance to be hydrogenated with protons to generate an organic hydride.

The cathode catalyst layer 10 contains, for example, platinum (Pt) or ruthenium (Ru) as a cathode catalyst for hydrogenating the substance to be hydrogenated. The average particle size of the cathode catalyst is, for example, 2 nm to 20 nm. The “average particle size” in the present embodiment means an average particle size D50 (particle size when the cumulative percentage reaches 50% from the side of the smaller size) obtained by, for example, image analysis of particles present in a scanning electron microscope (SEM) image at 1,000× magnification or a transmission electron microscope (TEM) image at 1,000,000× magnification. For example, in the case of 100 particles present in one visual field in a SEM image or a TEM image, the average particle size is obtained by analyzing the particles using image analysis software “Image J”. In a case where the particle size is of the order of μm, it is preferable to calculate the average particle size using a SEM image, and in a case where the particle size is of the order of nm, it is preferable to calculate the average particle size using a TEM image.

The cathode catalyst layer 10 also contains a porous catalyst support that supports the cathode catalyst. Having the catalyst support can suppress aggregation of the cathode catalyst. In addition, the surface area of the cathode catalyst layer 10 can be increased. The catalyst support is composed of an electron-conductive material such as porous carbon, a porous metal, or a porous metal oxide. In a case where the catalyst support is in the form of particles, the average particle size of the catalyst supports is, for example, 1 μm to 10 μm.

Furthermore, the cathode catalyst is coated with an ionomer (cation exchange ionomer). For example, the catalyst support which is in the state of supporting the cathode catalyst is coated with an ionomer. Examples of the ionomer include a perfluorosulfonic acid polymer such as Nafion (registered trademark) or Flemion (registered trademark). It is preferable that the cathode catalyst is partially coated with the ionomer. Such partial coating allows three elements (the substance to be hydrogenated, a proton, and an electron) necessary for an electrochemical reaction in the cathode catalyst layer 10 to be efficiently supplied to the reaction field.

The cathode catalyst layer 10 of the present embodiment also contains a non-porous body. The non-porous body impedes the flow of the substance to be hydrogenated and the organic hydride. The non-porous body includes aggregates of arbitrary primary particles. The primary particles included in the aggregates are preferably non-porous. Furthermore, the non-porous body is preferably inert to an electrolytic reduction reaction.

Examples of the primary particles include polytetrafluoroethylene (PTFE), perfluoroalkoxy alkane (PFA), and polyvinylidene fluoride (PVDF). The aggregates may include only one kind of primary particles or a combination of two or more kinds of primary particles. In addition, the cathode catalyst layer 10 may contain only one kind of aggregate or a combination of two or more kinds of aggregates. In other words, the non-porous body contains at least one substance selected from the group consisting of these candidate materials.

As for the “aggregate” in the present embodiment, in a case where a primary particle agglomerate having a size of 3 times or greater the size of the smallest primary particle agglomerate is present when a cross-section of the cathode catalyst layer 10 is observed (for example, SEM observation), it is determined that the primary particle agglomerate is an aggregate. Furthermore, in a case where a primary particle agglomerate having a size of 3 times or greater the size of the primary particles that are used is present, it is determined that the primary particle agglomerate is an aggregate. As an example, the size of the aggregate is, in the particle agglomerate in an image, the distance between two points on the contour of the particle agglomerate in the portion where the distance between two points is maximum.

Whether the primary particles are aggregated in the cathode catalyst layer 10 can be determined by an aggregation determination method presented below as an example. That is, an image (for example, a SEM image) of a cross-section of the cathode catalyst layer 10 is analyzed first to calculate the number-based particle size distribution of the primary particle agglomerates. In the particle size distribution, a primary particle agglomerate having a particle size of three times or greater the minimum particle size is determined as a target particle agglomerate. In a case where primary particles with a known particle size are used, a primary particle agglomerate having a particle size of three times or greater the particle size of the primary particles may be determined as the target particle agglomerate. Then, the area-based particle size distribution is calculated from the number and the particle size of each particle agglomerate in the number-based particle size distribution. When the ratio of the area of the target particle agglomerate to the total area of the primary particle agglomerates is 20% or higher in the obtained area-based particle size distribution, it is possible to determine that the primary particles are aggregated.

The catalyst support supporting the cathode catalyst and the non-porous body exist in a state of being mixed with each other in the cathode catalyst layer 10. Thus, the non-porous body is scattered in the cathode catalyst layer 10. For example, the non-porous body is almost uniformly dispersed in the cathode catalyst layer 10. In a case where the non-porous body is in the form of particles, the average particle size of the non-porous bodies is, for example, 10 nm to 30 μm. The content of the non-porous body in the cathode catalyst layer 10 is higher than 10 vol % in terms of the volume fraction with respect to the volume of the total solid content of the cathode catalyst layer 10. The volume fraction is preferably 11 vol % or higher, 12 vol % or higher, 13 vol % or higher, or 14 vol % or higher, more preferably 15 vol % or higher, and even more preferably 20 vol % or higher. In addition, the volume fraction of the non-porous body is preferably 80 vol % or lower and more preferably 70 vol % or lower with respect to the volume of the total solid content of the cathode catalyst layer 10.

By setting the volume fraction of the non-porous body to higher than 10 vol %, Faraday efficiency of the organic hydride producing device 1 can be improved. Furthermore, by setting the volume fraction of the non-porous body to 15 vol % or higher, the Faraday efficiency improving effect can be more reliably exhibited. In addition, by setting the volume fraction of the non-porous body to 20 vol % or higher, a greater Faraday efficiency improving effect can be obtained. In addition, by setting the volume fraction of the non-porous body to 80 vol % or lower, conductivity required for the organic hydride producing device 1 is easily obtained. In addition, by setting the volume fraction of the non-porous body to 70 vol % or lower, the organic hydride producing device 1 can have more preferable conductivity.

In the present embodiment, being “non-porous” means that the porosity is smaller than that of the porous catalyst support. Alternatively, being “non-porous” means that transmissivity for a fluid such as water, the substance to be hydrogenated, or the organic hydride is lower than that of the porous catalyst support. Alternatively, being “non-porous” means that, in a scanning electron microscope (SEM) image (for example, at 5,000× magnification), the number of pores observed is smaller than that in the porous catalyst support, or no pores are observed. Alternatively, being “non-porous” means that pores through which a fluid can enter or pass are not present.

A cathode catalyst ink used for forming the cathode catalyst layer 10 can be prepared, for example, by the following procedure. In a method for preparing a cathode catalyst ink according to the present embodiment, a first preparation step, a second preparation step, and an aggregation step are performed in this order.

First, in the first preparation step, a first solution is prepared by mixing the cathode catalyst, the catalyst support, the ionomer, and a solvent. For example, the first solution is obtained by putting each of the components into a pulverizing container and mixing the components using a stirrer such as a jet mill or a planetary rotating mixer. Examples of the solvent include water and alcohol. The catalyst support may be used in a state of supporting the cathode catalyst.

Next, in the second preparation step, a second solution is prepared by adding a dispersion of arbitrary primary particles to the first solution. The dispersion is a solution containing primary particles, a surfactant, and a solvent, in which micelles of the surfactant containing the primary particles are colloidally dispersed in the solvent. The amount of the dispersion added is set so that the volume fraction of the non-porous body in the cathode catalyst layer to be finally obtained is higher than 10 vol % with respect to the volume of the total solid content of the cathode catalyst layer 10. The amount of the dispersion added, in other words, the volume fraction of the non-porous body in the cathode catalyst layer 10 can be calculated from the weight fraction and the density of each component contained in the cathode catalyst layer 10. In an example of the calculation, a bulk density obtained by taking voids into consideration is used as the density of the cathode catalyst. Furthermore, a true density obtained without taking the voids into consideration is used as the densities of the primary particles and the ionomer.

In the subsequent aggregation step, the non-porous body including aggregates of the primary particles is formed by aggregating the primary particles in the second solution by a predetermined treatment. Examples of the predetermined treatment include a long-time weak mixing treatment and a short-time strong mixing treatment. Examples of the weak mixing treatment include application of ultrasonic vibration to the second solution. The duration of performing the weak mixing treatment, that is, the “long time” in the case of performing the weak mixing treatment is, for example, longer than 40 minutes and preferably 60 minutes or longer. Therefore, in an example of the weak mixing treatment, a treatment that is performed for 40 minutes or shorter is a short-time weak mixing treatment. Examples of the strong mixing treatment include stirring the second solution with a stirrer such as a jet mill or a planetary rotating mixer. The duration of performing the strong mixing treatment, that is, the “short time” in the case of performing the strong mixing treatment is, for example, 300 seconds or shorter. The present inventors have confirmed that the aggregates are not formed in a short-time weak mixing treatment. The combination of the mixing strength and the mixing time that enables the primary particles to be aggregated can be appropriately set by those practicing the art.

By performing the above steps, the cathode catalyst ink containing the cathode catalyst, the catalyst support, the ionomer, the solvent, and the non-porous body is obtained. The cathode catalyst layer 10 is formed by using the cathode catalyst ink. For example, the first surface 2a of the electrolyte membrane 2 is coated with the cathode catalyst ink, or the cathode catalyst ink applied to a predetermined sheet is transferred onto the electrolyte membrane 2, thereby forming the cathode catalyst layer 10.

The thickness of the cathode catalyst layer 10 is not particularly limited, and is, for example, 20 μm to 50 μm. By setting the thickness of the cathode catalyst layer to 20 μm or greater, the amount of a catalyst necessary for an electrolytic reaction can be more reliably obtained. Furthermore, by setting the thickness of the cathode catalyst layer 10 to 50 μm or less, it is possible to inhibit diffusivity of the substance to be hydrogenated from becoming excessively low.

The cathode diffusion layer 12 is a layer uniformly diffusing a liquid substance to be hydrogenated supplied from the outside into the cathode catalyst layer 10. An organic hydride generated in the cathode catalyst layer 10 is discharged to the outside of the cathode catalyst layer 10 through the cathode diffusion layer 12. The cathode diffusion layer 12 of the present embodiment is in contact with a main surface of the cathode catalyst layer 10 on the side opposite to the electrolyte membrane 2.

The cathode diffusion layer 12 is formed of a conductive material such as carbon or a metal. In addition, the cathode diffusion layer 12 is a porous body such as a sintered body of fibers or particles or a foamed molded body. Specific examples of the material forming the cathode diffusion layer 12 include a carbon woven fabric (carbon cloth), a carbon nonwoven fabric, and carbon paper. The thickness of the cathode diffusion layer 12 is not particularly limited, and is, for example, 200 μm to 700 μm. By setting the thickness of the cathode diffusion layer 12 to 200 μm or greater, diffusivity of the substance to be hydrogenated can be more reliably enhanced. Furthermore, by setting the thickness of the cathode diffusion layer 12 to 700 μm or less, it is possible to inhibit electrical resistance from becoming excessively large.

The anode 6 (positive electrode) is provided on the second surface 2b side of the electrolyte membrane 2. The anode 6 of the present embodiment is in contact with the second surface 2b of the electrolyte membrane 2. The anode 6 has, for example, a metal such as iridium (Ir), ruthenium (Ru), or platinum, or a metal oxide thereof as an anode catalyst and generates protons by oxidizing water. The anode catalyst may be dispersedly supported or applied on a base material having electron conductivity. The base material is formed of a material containing, for example, a metal such as titanium (Ti) or stainless steel (SUS) as a main component. Examples of the form of the base material include a woven fabric sheet or a nonwoven fabric sheet (fiber diameter: for example, 10 μm to 30 μm), a mesh (diameter: for example, 500 μm to 1,000 μm), a porous sintered body, a foamed molded body (foam), and an expanded metal.

In a case where the anode 6 has a structure in which the anode catalyst is dispersedly supported or applied on the base material, the thickness of the anode 6 containing the anode catalyst and the base material is not particularly limited, and is, for example, 0.05 to 1 mm. By setting the thickness of the anode 6 to 0.05 mm or greater, the amount of the catalyst necessary for an electrolytic reaction can be more reliably obtained. Furthermore, by setting the thickness of the anode 6 to 1 mm or less, it is possible to inhibit the diffusivity of the substance to be hydrogenated from becoming excessively low.

In a case where the anode catalyst is applied on the base material to form a layer, the thickness of the layer is not particularly limited, and is, for example, 0.1 μm to μm. The anode 6 may also be composed of a layer formed by direct coating or the like of a main surface of the electrolyte membrane 2 with the anode catalyst. In this case, the thickness of the layer constituting the anode 6 is not particularly limited, and is, for example, 0.1 μm to 50 μm. By setting the thickness of the layer to 0.1 μm or greater, the amount of the catalyst necessary for the electrolytic reaction can be more reliably obtained. Furthermore, by setting the thickness of the layer to 50 μm or less, it is possible to inhibit the diffusivity of the substance to be hydrogenated from becoming excessively low.

The pair of end plates 8 are composed of, for example, a metal such as stainless steel or titanium. The thickness of each end plate 8 is not particularly limited, and is, for example, 1 mm to 30 mm. By setting the thickness of the end plate 8 to 1 mm or greater, significant impairment of workability can be avoided. Furthermore, by setting the thickness of the end plate 8 to 30 mm or less, an increase in the cost can be suppressed.

One end plate 8a is installed on the cathode 4 on the side opposite to the electrolyte membrane 2. The end plate 8a of the present embodiment is in contact with a main surface of the cathode diffusion layer 12. The organic hydride producing device 1 includes a frame-shaped spacer 14 disposed between the electrolyte membrane 2 and the end plate 8a. A cathode chamber in which the cathode 4 is accommodated is defined by the end plate 8a, the electrolyte membrane 2, and the spacer 14. The spacer 14 also serves as a sealing material for preventing a catholyte from leaking to the outside of the cathode chamber.

The catholyte is a liquid mixture of the substance to be hydrogenated and the organic hydride supplied to the cathode chamber. The substance to be hydrogenated is a compound which is hydrogenated by an electrochemical reduction reaction in the organic hydride producing device 1 to become an organic hydride, in other words, a dehydrogenated product of the organic hydride. The substance to be hydrogenated is preferably a liquid at 20° C. and 1 atm. As an example, the catholyte does not contain an organic hydride before the start of the operation of the organic hydride producing device 1, and after the start of the operation, the organic hydride generated by electrolysis is mixed in, whereby the catholyte becomes the liquid mixture of the substance to be hydrogenated and the organic hydride.

The substance to be hydrogenated and the organic hydride used in the present embodiment are not particularly limited as long as they are organic compounds to or from which hydrogen can be added/removed by reversibly causing a hydrogenation reaction/dehydrogenation reaction, and an acetone-isopropanol type, a benzoquinone-hydroquinone type, an aromatic hydrocarbon type, or the like can be widely used. Among these, an aromatic hydrocarbon type is preferable from the viewpoint of transportability during energy transport or the like.

An aromatic hydrocarbon compound used as the substance to be hydrogenated is a compound containing at least one aromatic ring, and examples thereof include benzene, alkylbenzenes, naphthalene, alkylnaphthalenes, anthracene, and diphenylethane. Alkylbenzenes include a compound in which 1 to 4 hydrogen atoms in the aromatic ring are substituted with a linear alkyl group or a branched alkyl group having 1 to 6 carbon atoms. Examples of a such a compound include toluene, xylene, mesitylene, ethylbenzene, and diethylbenzene. Alkylnaphthalenes include a compound in which 1 to 4 hydrogen atoms in the aromatic ring are substituted with a linear alkyl group or a branched alkyl group having 1 to 6 carbon atoms. Examples of such a compound include methylnaphthalene. These compounds may be used alone or in combination.

The substance to be hydrogenated is preferably at least one of toluene and benzene. It is also possible to use a nitrogen-containing heterocyclic aromatic compound such as pyridine, pyrimidine, pyrazine, quinoline, isoquinoline, N-alkylpyrrole, N-alkylindole, or N-alkyldibenzopyrrole as the substance to be hydrogenated. The organic hydride is obtained by hydrogenating the above-described substance to be hydrogenated, and examples thereof include cyclohexane, methylcyclohexane, dimethylcyclohexane, and piperidine.

The end plate 8a has a supply flow path 16 and a discharge flow path 18 on a main surface facing the cathode diffusion layer 12 side. The supply flow path 16 and the discharge flow path 18 of the present embodiment are constituted of grooves provided on the main surface of the end plate 8a. The supply flow path 16 is in contact with one end side of the cathode diffusion layer 12 in the in-plane direction, and the catholyte to be supplied to the cathode 4 flows within the supply flow path 16. The discharge flow path 18 is in contact with the other end side of the cathode diffusion layer 12 in the in-plane direction, and the catholyte discharged from the cathode 4 flows within the discharge flow path 18. The in-plane direction of the cathode diffusion layer 12 is the direction in which a plane orthogonal to the stacking direction of the electrolyte membrane 2 and the cathode 4 extends.

In the present embodiment, the supply flow path 16 is in contact with the lower end of the cathode diffusion layer 12 in the vertical direction, and the discharge flow path 18 is in contact with the upper end of the cathode diffusion layer 12. Each of the flow paths extends in the horizontal direction. A groove-like flow path that connects the supply flow path 16 and the discharge flow path 18 may be provided on the surface of the end plate 8a. By providing such a flow path, an uneven flow of the substance to be hydrogenated in the cathode chamber or excessive loss of pressure that the catholyte receives when passing through the cathode chamber can be suppressed. The extending directions and the shapes of the supply flow path 16, the discharge flow path 18, and the flow path connecting the two flow paths are not limited to those described above, and can be appropriately set by those practicing the art.

A catholyte storage tank (not shown) is connected to the supply flow path 16. The catholyte is stored in the catholyte storage tank. Between the supply flow path 16 and the catholyte storage tank, a catholyte supply device (not shown) constituted of various pumps such as a gear pump and a cylinder pump or a gravity flow device is provided. The catholyte stored in the catholyte storage tank is sent to the supply flow path 16 by the catholyte supply device and supplied to the cathode catalyst layer 10 through the cathode diffusion layer 12. The discharge flow path 18 is connected to the catholyte storage tank as an example. The catholyte containing the organic hydride generated in the cathode catalyst layer 10 and the unreacted substance to be hydrogenated is returned to the catholyte storage tank via the discharge flow path 18.

The other end plate 8b is installed on the anode 6 on the side opposite to the electrolyte membrane 2. The organic hydride producing device 1 includes a frame-shaped spacer 20 disposed between the electrolyte membrane 2 and the end plate 8b. An anode chamber in which the anode 6 is accommodated is defined by the end plate 8b, the electrolyte membrane 2, and the spacer 20. The spacer 20 also serves as a sealing material for preventing an anolyte from leaking to the outside of the anode chamber. The anolyte is a liquid containing water to be supplied to the anode chamber. Examples of the anolyte include an aqueous sulfuric acid solution, an aqueous nitric acid solution, an aqueous hydrochloric acid solution, pure water, and ion-exchanged water.

The end plate 8b has a supply flow path 22, a discharge flow path 24, and a connecting flow path 26 on a main surface facing the anode 6 side. The supply flow path 22, the discharge flow path 24, and the connecting flow path 26 of the present embodiment are constituted of grooves provided on the main surface of the end plate 8b. The supply flow path 22 is in contact with one end side of the anode 6 in the in-plane direction, and the anolyte to be supplied to the anode 6 flows within the supply flow path 22. The discharge flow path 24 is in contact with the other end side of the anode 6 in the in-plane direction, and the anolyte discharged from the anode 6 flows within the discharge flow path 24. One end of the connecting flow path 26 is connected to the supply flow path 22, and the other end is connected to the discharge flow path 24.

In the present embodiment, the supply flow path 22 is in contact with the lower end of the anode 6 in the vertical direction, and the discharge flow path 24 is in contact with the upper end of the anode 6. The supply flow path 22 and the discharge flow path 24 extend in the horizontal direction, and the connecting flow path 26 extends in the vertical direction. In addition, the end plate 8b are provided with a plurality of the connecting flow paths 26, and the connecting flow paths 26 are arranged in the horizontal direction with predetermined gaps therebetween. The extending directions and the shapes of the supply flow path 22, the discharge flow path 24, and the connecting flow path 26 are not limited to those described above, and can be appropriately set by those practicing the art.

The anode chamber may also accommodate an electron-conductive buffer material that is disposed between the anode 6 and the end plate 8b and presses the anode 6 against the electrolyte membrane 2. The buffer material can reduce contact resistance between the electrolyte membrane 2 and the anode 6. The buffer material may be pressed against the anode 6 by a biasing member such as a spring. Furthermore, the buffer material may be constituted of a flow path block in which slits constituting the supply flow path 22, the discharge flow path 24, and the connecting flow path 26 are formed. In this case, the end plate 8b can be constituted of a plate that does not have the groove forming each flow path.

An anolyte storage tank (not shown) is connected to the supply flow path 22. The anolyte is stored in the anolyte storage tank. Between the supply flow path 22 and the anolyte storage tank, an anolyte supply device (not shown) constituted of various pumps such as a gear pump and a cylinder pump or a gravity flow device is provided. The anolyte stored in the anolyte storage tank is sent to the supply flow path 22 by the anolyte supply device, and some of the anolyte is directly supplied to the anode 6, while the rest of the anolyte is supplied to the anode 6 via the connecting flow path 26. The discharge flow path 24 is connected to the anolyte storage tank as an example. The anolyte supplied to the anode 6 is returned to the anolyte storage tank via the discharge flow path 24.

A controller (not shown) may be connected to the organic hydride producing device 1. The controller controls a cell voltage (electrolysis voltage) of the organic hydride producing device 1 or a current flowing through the organic hydride producing device 1. As a hardware configuration, the controller is realized by an element or a circuit such as a CPU or a memory of a computer, and as a software configuration, the controller is realized by a computer program or the like.

A signal indicating a potential of each electrode or the cell voltage of the organic hydride producing device 1 from a potential detector (not shown) provided in the organic hydride producing device 1 is input to the controller. The potential of each electrode and the cell voltage of the organic hydride producing device 1 can be detected by a known method. As an example, a reference electrode is provided on the electrolyte membrane 2. The potential of the reference electrode is retained at a reference electrode potential. The reference electrode is, for example, a reversible hydrogen electrode (RHE). The potential detector detects the potential of each electrode with respect to the reference electrode and sends the detection result to the controller. The potential detector is constituted of, for example, a known voltmeter.

The controller controls the output of a power source or the driving of the catholyte supply device and the anolyte supply device during the operation of the organic hydride producing device 1 based on the detection result of the potential detector. The power source of the organic hydride producing device 1 is preferably renewable energy obtained from solar light, wind power, hydraulic power, geothermal power generation, or the like, but is not limited thereto.

Reactions that occur in the organic hydride producing device 1 in a case where toluene (TL) is used as an example of the substance to be hydrogenated are as follows. The organic hydride obtained in a case where toluene is used as the substance to be hydrogenated is methylcyclohexane (MCH).

Electrode Reaction in Anode

3H₂O→3/2O₂+6H⁺+6e⁻

Electrode Reaction in Cathode

TL+6H⁺+6e⁻→MCH

That is, the electrode reaction in the cathode catalyst layer 10 and the electrode reaction in the anode 6 proceed in parallel. Then, the protons generated in the anode 6 by the electrolysis of water are supplied to the cathode catalyst layer 10 through the electrolyte membrane 2. The electrons generated by the electrolysis of water are also supplied to the cathode catalyst layer 10 through the end plate 8b, an external circuit, and the end plate 8a. The protons and electrons supplied to the cathode catalyst layer are used for the hydrogenation of toluene in the cathode catalyst layer 10. As a result, methylcyclohexane is generated.

According to the organic hydride producing device 1 according to the present embodiment, the electrolysis of water and the hydrogenation reaction of the substance to be hydrogenated can thus be performed in one step. Therefore, organic hydride production efficiency can be increased compared to a conventional technique in which the organic hydride is produced by a two-step process which includes a process of producing hydrogen by water electrolysis or the like and a process of chemically hydrogenating toluene in a reactor such as a plant. Furthermore, since the reactor for performing the chemical hydrogenation and a high-pressure vessel for storing the hydrogen produced by the water electrolysis or the like are not required, a significant reduction in facility cost can be achieved.

In the cathode 4, the following hydrogen-generating reaction can occur as a side reaction along with the toluene hydrogenation reaction which is the main reaction. The side reaction can occur, for example, in a case where the amount of the substance to be hydrogenated supplied to the cathode catalyst layer 10 is insufficient. The occurrence of the side reaction leads to reduction in the Faraday efficiency of the organic hydride producing device 1.

Side Reaction That Can Occur at Cathode

2H⁺+2e⁻→H₂

When the protons travel from the anode 6 side to the cathode 4 side through the electrolyte membrane 2, they travel together with water molecules. Therefore, water accumulates in the cathode catalyst layer 10 as the electrolytic reduction reaction proceeds. Water in the cathode catalyst layer 10 impedes the flow of the substance to be hydrogenated. Therefore, when a large amount of water accumulates in the cathode catalyst layer 10, the amount of the substance to be hydrogenated supplied to the reaction field of the cathode catalyst layer 10 decreases, and the side reaction described above is more likely to proceed.

When water travelling from the anode 6 side starts to accumulate in the cathode catalyst layer 10, the substance to be hydrogenated and the organic hydride flow in the cathode catalyst layer 10 while avoiding the water. Such avoiding occurs, because higher pressure is required in order for the substance to be hydrogenated and the organic hydride to flow in a region where water exists than in the case of flowing in a region where water does not exist. Therefore, water that accumulated in the cathode catalyst layer 10 tends to remain in the cathode catalyst layer 10 without being swept away by the substance to be hydrogenated and the organic hydride.

Meanwhile, the cathode catalyst layer 10 of the present embodiment contains the non-porous body. The non-porous body impedes the flow of the substance to be hydrogenated and the organic hydride. Therefore, at least a portion of the flow of the substance to be hydrogenated and the organic hydride avoiding water is forced by the non-porous body to switch the direction towards the accumulated water. As a result, the substance to be hydrogenated and the organic hydride hit against the water accumulated in the cathode catalyst layer 10, whereby the water is swept away to the outside of the cathode catalyst layer 10. Therefore, the non-porous body contained in the cathode catalyst layer 10 allows water travelling from the anode 6 side to be easily discharged to the outside of the cathode catalyst layer 10. Moreover, the non-porous body includes the aggregates of primary particles. Therefore, the size of the non-porous body is easily increased, and thus the flow-impeding effect of the non-porous body is more easily exhibited. As described above, it is possible to inhibit the side reaction from proceeding due to an insufficient amount of the substance to be hydrogenated supplied to the cathode catalyst layer 10.

As described above, the cathode catalyst layer 10 according to the present embodiment includes the non-porous body including the aggregates of arbitrary primary particles. The volume fraction of the non-porous body in the cathode catalyst layer 10 is higher than 10 vol % with respect to the volume of the total solid content of the cathode catalyst layer 10. By setting the amount of the non-porous body including the aggregates in the cathode catalyst layer 10 to higher than 10 vol %, water travelling from the anode 6 side to the cathode catalyst layer 10 can be rapidly discharged outside the system. Therefore, according to the present embodiment, the Faraday efficiency of the organic hydride producing device 1 can be improved.

In addition, the primary particles included in the aggregates are preferably non-porous. As a result, the flow-impeding effect of the non-porous body on the substance to be hydrogenated or the like can be more likely to be exhibited. Furthermore, the non-porous body is preferably inert to the electrolytic reduction reaction. As a result, a cost increase resulting from the inclusion of the non-porous body in the cathode catalyst layer 10 can be more likely to be suppressed.

Hereinabove, the embodiments of the present invention have been described in detail. The above-described embodiments are merely specific examples for carrying out the present invention. The contents of the embodiments do not limit the technical scope of the present invention, and many design changes such as changes, additions, and deletions of components can be made without departing from the spirit of the invention defined in the claims. A new embodiment to which the design change is made has the combined effect of each of the embodiment and the modification. In the above-described embodiment, the contents that can be subjected to such design changes are emphasized with notations such as “of the present embodiment” and “in the present embodiment”, but the design changes are allowed even in the contents without such notations. Any combination of the above-described components is also effective as an aspect of the present invention.

The embodiments may also be specified as the items described below.

Item 1

A cathode catalyst layer (10) that hydrogenates a substance to be hydrogenated with a proton to generate an organic hydride, the cathode catalyst layer (10) including

a cathode catalyst to hydrogenate the substance to be hydrogenated, a porous catalyst support supporting the cathode catalyst, and a non-porous body including an aggregate (30) of arbitrary primary particles,

in which the volume fraction of the non-porous body in the cathode catalyst layer (10) is higher than 10 vol % with respect to the volume of the total solid content of the cathode catalyst layer (10).

Item 2

The cathode catalyst layer (10) according to Item 1, in which the primary particles are non-porous.

Item 3

The cathode catalyst layer (10) according to Item 1 or 2,

in which the non-porous body is inert to an electrolytic reduction reaction.

Item 4

An organic hydride producing device (1) including an electrolyte membrane (2) having a first surface (2a) and a second surface (2b) facing away from each other and transporting a proton,

a cathode (4) provided on the first surface (2a) side of the electrolyte membrane (2) and having the cathode catalyst layer (10) according to any one of Items 1 to 3, and

an anode (6) provided on the second surface (2b) side of the electrolyte membrane (2) and oxidizing water to generate a proton.

Item 5

A method for preparing a cathode catalyst ink used in a cathode catalyst layer (10) that hydrogenates a substance to be hydrogenated with a proton to generate an organic hydride, the method including

preparing a first solution by mixing a cathode catalyst, a porous catalyst support for supporting the cathode catalyst, and a solvent,

preparing a second solution by adding to the first solution a dispersion of arbitrary primary particles, the amount of the dispersion being set so that a volume fraction of a non-porous body in the cathode catalyst layer is higher than 10 vol % with respect to the volume of the total solid content of the cathode catalyst layer (10), and

forming the non-porous body including an aggregate (30) of the primary particles by aggregating the primary particles in the second solution.

### EXAMPLES

Examples of the present invention will be described below, but these examples are merely examples for suitably describing the present invention, and do not limit the present invention in any way.

Methods for forming aggregates and the effects of the aggregates on the performance of an organic hydride producing device were verified by the following Examples 1 and 2 and Comparative Examples 1 to 3.

### Example 1

### Preparation of Cathode Catalyst Ink

A PtRu/C catalyst (TEC61E54E, manufactured by Tanaka Kikinzoku Kogyo), pure water, a 20 wt % Nafion (registered trademark) solution (manufactured by DuPont de Nemours, Inc.), and 1-propanol (manufactured by Wako Pure Chemical Industries, Ltd.) were placed in a pulverizing container and mixed by a jet mill to prepare a first solution. The first solution was mixed with a PTFE dispersion (manufactured by CHEMOURS-MITSUI FLUOROPRODUCTS CO., LTD.), thus obtaining a second solution. The particle size of the PTFE particles contained in the PTFE dispersion is 20 nm. Then, the second solution was mixed using an ultrasonic cleaner (output: 125 W, frequency: 42 kHz) for 240 minutes. This mixing treatment corresponds to a long-time weak mixing treatment. By performing the above steps, a cathode catalyst ink was obtained. The Nafion/carbon ratio of the cathode catalyst ink was 0.3. The amount of the PTFE dispersion added in the cathode catalyst ink was set so that the volume fraction of the non-porous body (aggregates of PTFE) with respect to the volume of the total solid content of the cathode catalyst layer to be finally obtained was 70 vol %.

### Preparation of Membrane Electrode Assembly

A cathode catalyst layer was formed by coating Nafion (registered trademark) N117 (manufactured by DuPont de Nemours, Inc.) serving as an electrolyte membrane with the cathode catalyst ink. Subsequently, a carbon paper (39BA, manufactured by SGL CARBON Japan Ltd., 10 cm×10 cm) serving as a cathode diffusion layer and the electrolyte membrane on which the cathode catalyst layer was formed were superposed, whereby a membrane electrode assembly was prepared. The amount of a catalytic metal in the membrane electrode assembly was 0.60 mg/cm².

### Preparation of Organic Hydride Producing Device

A web-like DSE (Dimensionally Stable Electrode) electrode (manufactured by De Nora Permelec Ltd) obtained by coating a 1-mm thick Ti substrate with IrTa oxide was prepared as an anode. The geometric area of the anode is 12.25 cm². Then, the membrane electrode assembly and the anode were laminated to each other. In addition, a flow path block in which slits extending in the vertical direction were formed was pressed against the anode by a spring. The flow path block pressed against the anode was sandwiched between a pair of end plates, which were then fastened with a bolt and a nut. As a result, an organic hydride producing device was obtained.

### Example 2

A cathode catalyst ink was prepared in the same manner as in Example 1, except that the second solution was mixed using a stirrer (THINKY MIXER AR-100, manufactured by THINKY CORPORATION) for 30 seconds, to obtain an organic hydride producing device. The mixing treatment performed on the second solution in Example 2 corresponds to a short-time strong mixing treatment.

### Comparative Example 1

A cathode catalyst ink was prepared in the same manner as in Example 1, except that the cathode catalyst ink was not mixed with PTFE, to obtain an organic hydride producing device.

### Comparative Example 2

A cathode catalyst ink was prepared in the same manner as in Example 1, except that the amount of the PTFE dispersion added was set so that the volume fraction was 50 vol %, and the second solution was mixed using the ultrasonic cleaner (output: 125 W, frequency: 42 kHz) for 30 minutes, to obtain an organic hydride producing device. The mixing treatment performed on the second solution in Comparative Example 2 corresponds to a short-time weak mixing treatment.

### Comparative Example 3

A PtRu/C catalyst (TEC61E54E, manufactured by Tanaka Kikinzoku Kogyo), pure water, a 20 wt % Nafion (registered trademark) solution (manufactured by DuPont de Nemours, Inc.), 1-propanol (manufactured by Wako Pure Chemical Industries, Ltd.), and PTFE particles (manufactured by Solvay SA) were placed in a ball mill container and mixed, thus obtaining an ink for a cathode catalyst. The particle size of the PTFE particles is 4 μm. The Nafion/carbon ratio of the cathode catalyst ink was 0.3. The amount of the PTFE particles added in the cathode catalyst ink was set so that the volume fraction of the non-porous body with respect to the volume of the total solid content of the cathode catalyst layer to be finally obtained was 50 vol %.

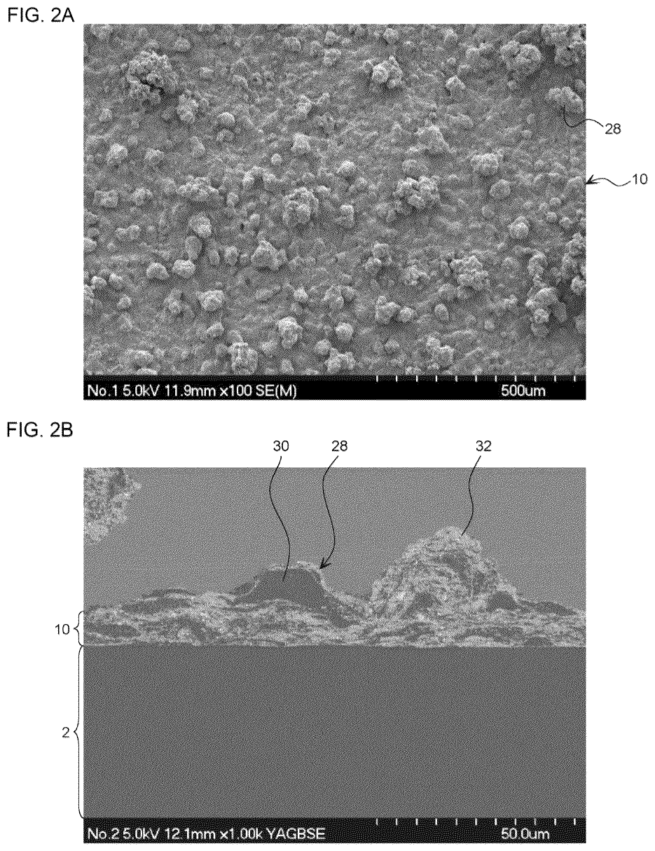

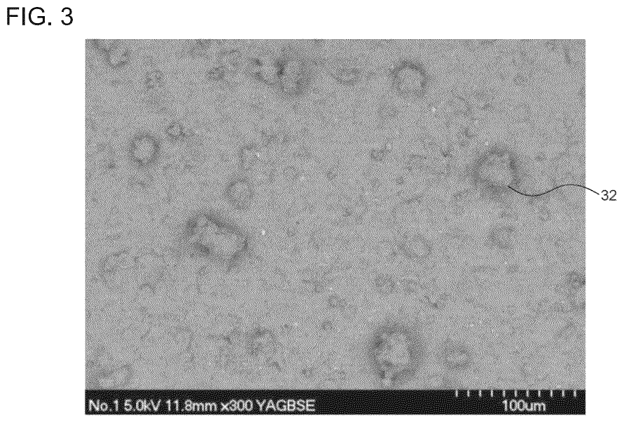

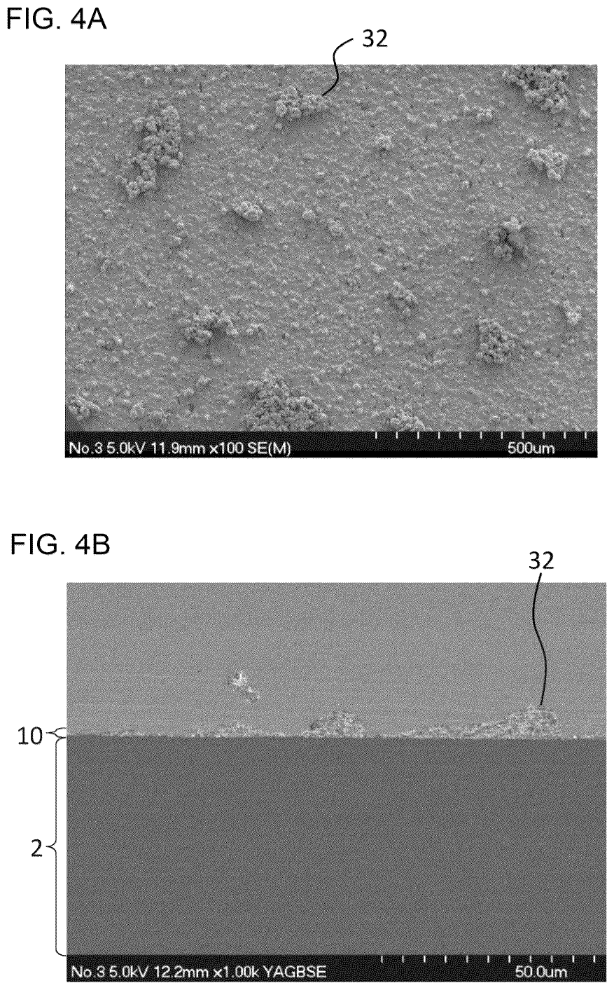

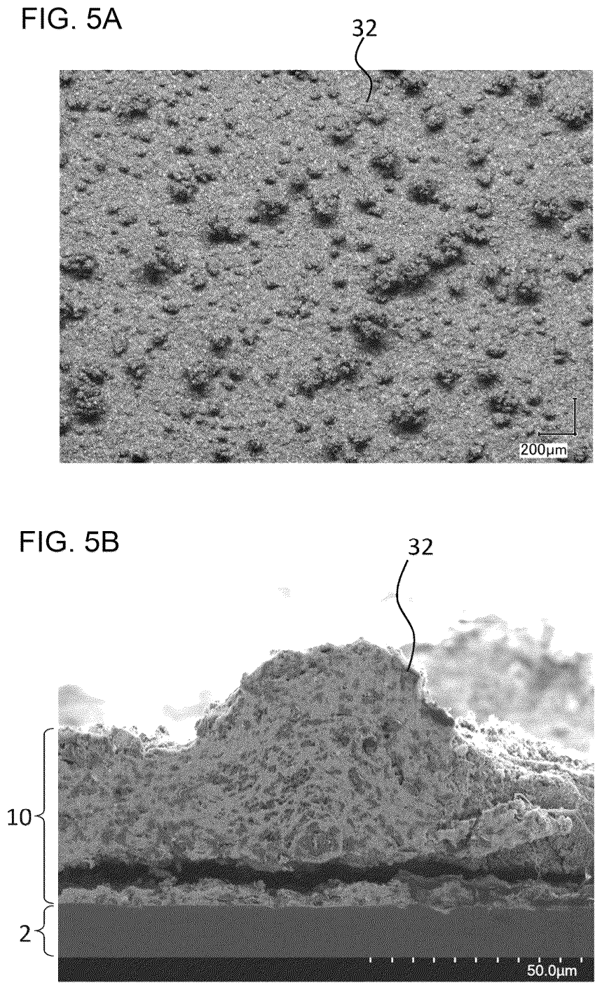

A surface and a cross-section of the cathode catalyst layer obtained in each of Example 1 and Comparative Examples 2 and 3 were observed by SEM. Furthermore, a surface of the cathode catalyst layer obtained in Comparative Example 1 was observed by SEM. FIG. 2A is a SEM image of the surface of the cathode catalyst layer 10 according to Example 1. FIG. 2B is a SEM image of the cross-section of the cathode catalyst layer 10 according to Example 1. FIG. 3 is a SEM image of the surface of the cathode catalyst layer according to Comparative Example 1. FIG. 4A is a SEM image of the surface of the cathode catalyst layer according to Comparative Example 2. FIG. 4B is a SEM image of a cross-section of the cathode catalyst layer according to Comparative Example 2. FIG. 5A is a SEM image of the surface of the cathode catalyst layer according to Comparative Example 3. FIG. 5B is a SEM image of a cross-section of the cathode catalyst layer according to Comparative Example 3. The magnifications of the SEM images of FIGS. 2A, 3, 4A, and are 100×, and the magnifications of the SEM images of FIGS. 2B, 4B, and 5B are 1,000×.

As shown in FIG. 2A, it was confirmed that many protrusions 28 of about 10 μm to 30 μm were scattered on the surface of the cathode catalyst layer 10 of Example 1. In addition, as shown in FIG. 2B, it was confirmed that the protrusion 28 contained a PTFE aggregate 30 of about 1 μm to 20 μm. From this, it is possible to understand that aggregates of primary particles, in other words, the non-porous body in the above-described embodiment can be formed by adding a dispersion of primary particles to a liquid mixture (first solution) of a cathode catalyst and the like prepared in advance and subjecting the solution (second solution) to a long-time weak mixing treatment.

As shown in FIG. 3, a small number of protrusions 32 were also observed on the surface of the cathode catalyst layer of Comparative Example 1. However, the protrusions 32 did not contain the aggregates 30. The protrusions 32 are formed due to uneven application of the cathode catalyst ink or the like, and are mainly composed of a catalyst support. The cathode catalyst layer 10 of Example 1 also contains the protrusion 32 composed of the catalyst support, and the white bulged portion that appears in the SEM image of FIG. 2B corresponds to the protrusion 32.

As shown in FIGS. 4A and 5A, the protrusions 32 are also observed on the surfaces of the cathode catalyst layers of Comparative Examples 2 and 3. However, such protrusions 32 did not contain the aggregates 30, as shown in FIGS. 4B and 5B. From this, it is possible to understand that, even in a case where the dispersion of the primary particles is added to the liquid mixture of the cathode catalyst and the like prepared in advance, the aggregates are not formed by a short-time weak mixing treatment. It is also possible to understand that the aggregates are not formed as well in a case where the cathode catalyst and the like and the primary particles are mixed at the same time.

Although not shown, the cathode catalyst layer of Example 2 contained the aggregate 30. From this, it is possible to understand that the aggregates of the primary particles can be formed by adding the dispersion of the primary particles to the liquid mixture of the cathode catalyst and the like and subjecting the solution to a short-time strong mixing treatment.

### Measurement of Faraday Efficiency

Faraday efficiency of the organic hydride producing devices obtained in Examples 1 and 2 and Comparative Examples 1 and 2 were measured. Specifically, the anode chamber of the organic hydride producing device of each example and a sulfuric acid bottle were connected by a circulation path, and 1 M sulfuric acid was circulated as an anolyte at a flow rate of 20 mL/min. The cathode chamber and a toluene bottle were connected by a circulation path, and toluene was circulated as a catholyte at a flow rate of 20 mL/min. A voltage was applied between the anode and the cathode in a state of maintaining the temperature of the organic hydride producing device at 60° C., and a constant current was applied at a current density of 0.7 A/cm². The catholyte was collected from the toluene bottle at regular intervals, and the toluene and methylcyclohexane concentrations in the catholyte was quantified using a gas chromatograph mass spectrometer (GC-MS) (product name: JMS-T100 GCV, manufactured by JEOL Ltd.). From the obtained toluene and methylcyclohexane concentrations, the charge amount (A) used for the intended main reaction was calculated. Then, a ratio of A to the current (B) flowing during the reaction (A/B×100%), that is, the Faraday efficiency, was calculated.

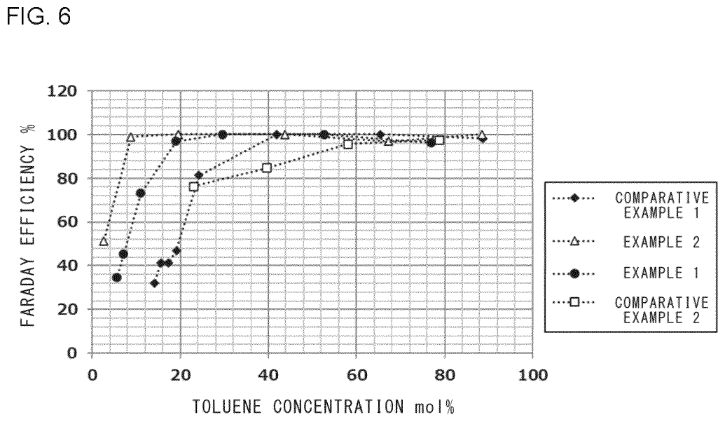

FIG. 6 is a diagram showing the correlation between the toluene concentration in a catholyte and the Faraday efficiency of an organic hydride producing device. As shown in FIG. 6, when the toluene concentration was about 40% or low, the Faraday efficiency was higher in the organic hydride producing devices of Examples 1 and 2 of which the cathode catalyst layers contained the non-porous body including the aggregates, compared to the organic hydride producing devices of Comparative Examples 1 and 2 of which the cathode catalyst layers did not contain the non-porous body including the aggregates. From this, it was confirmed that mixing the cathode catalyst layer with the non-porous body including the aggregates can suppress a reduction in the Faraday efficiency when the toluene concentration decreases, resulting in improvement of the Faraday efficiency of the organic hydride producing device.

It was confirmed from the comparison between Example 1 and Comparative Example 1 that the performance of the organic hydride producing device, specifically, the Faraday efficiency, can be improved by 20% or higher. In this case, the scale (size) of the organic hydride producing device can be reduced by 15% or more while maintaining the organic hydride production capacity.

The effects of the non-porous body including the aggregates on the performance of the organic hydride producing device were verified in more detail by the following Test Examples 1 to 23.

### Test Examples 1 to 11

Cathode catalyst inks were prepared in the same manner as in Comparative Example 3 with different amounts of the PTFE particles added in each Test Example to obtain organic hydride producing devices. PTFE particles having a particle size of 4 μm were used in Test Examples 1 to 8, and PTFE particles having a particle size of 10 μm were used in Test Examples 9 to 11. The PTFE particles having a particle size of 10 μm were adopted as particles having a size close to that of the aggregate. The amount of the PTFE particles added in Test Example 1 was 10 vol % in terms of the volume fraction of PTFE with respect to the volume of the total solid content of the cathode catalyst layer to be finally obtained. The amounts of the PTFE particles added in Test Examples 2 to 8 were 20, 30, 40, 50, 60, 70, and 80 vol %, respectively, in terms of the volume fraction. The amounts of the PTFE particles added in Test Examples 9 to 11 were 10, and 30 vol %, respectively, in terms of the volume fraction.

### Test Examples 12 and 13

Cathode catalyst inks were prepared in the same manner as in Comparative Example 2 with different amounts of the PTFE dispersion added in each Test Example to obtain organic hydride producing devices. The amounts of the PTFE dispersions added in Test Examples 12 and 13 were 30 and 50 vol %, respectively, in terms of the volume fraction.

### Test Examples 14 to 23

Cathode catalyst inks were prepared in the same manner as in Example 1 with different amounts of the PTFE dispersion added in each test to obtain organic hydride producing devices. The amounts of the PTFE particles added in Test Examples 14 to 23 were 5, 10, 15, 20, 30, 40, 50, 60, and 80 vol %, respectively, in terms of the volume fraction.

### Evaluation of Aggregation

The presence or absence of PTFE aggregates in the cathode catalyst layer in each Test Example was evaluated by the aggregation determining method described above. In the evaluation, the case of confirming the aggregates was evaluated as o, and the case of not confirming the aggregates was evaluated as x.

### Evaluation of Strength

The strength of each cathode catalyst layer (self-supporting property or shape-maintaining property) was evaluated. In the evaluation, the case of maintaining the shape of the cathode catalyst layer after performing a constant-current electrolysis test described below was evaluated as o, the case of being unable to continue the test due to a collapse of the cathode catalyst layer during the constant-current electrolysis test was evaluated as A, and the case of being unable to perform the constant-current electrolysis test due to a collapse of the cathode catalyst layer under its own weight was evaluated as x. o is an acceptable evaluation, and Δ and x are unacceptable evaluations. The cathode catalyst layers of which the strengths are evaluated as o have the strength equal to or greater than that of a conventional catalyst layer (corresponding to Comparative Example 1) obtained without the addition of the PTFE dispersion performed in Examples 1 and 2 and Comparative Example 2 or the addition of the PTFE particles performed in Comparative Example 3, in other words, without performing the PTFE addition of which the purpose is improving the Faraday efficiency by the water discharge effect of the non-porous body.

### Evaluation of Conductivity

The conductivity of the organic hydride producing device of each Test Example was evaluated. In the evaluation, the case of a resistance value in the organic hydride producing device calculated by a known method in the constant-current electrolysis test described below being equal to or lower than the resistance value (hereinafter, appropriately referred to as the conventional resistance value) in an organic hydride producing device (hereinafter, appropriately referred to as a conventional device) including the above-described conventional catalyst layer was evaluated as ⊙, the case of the resistance value in the organic hydride producing device being higher than 1 time and 2 times or lower the conventional resistance value was evaluated as and the case of the resistance value in the organic hydride producing device being higher than 2 times the conventional resistance value was evaluated as x. o and ⊙ are acceptable evaluations, and x is an unacceptable evaluation.

### Evaluation of Overall Faraday Efficiency Improving Effect

Using the organic hydride producing device of each Test Example, the following constant-current electrolysis test was performed. That is, first, 2 mol of toluene was supplied to each organic hydride producing device as the catholyte, and constant-current electrolysis was started. Then, a current was applied in an amount that can 100% electrochemically convert the 2 mol of toluene to methylcyclohexane. The conditions conformed to those in Measurement of Faraday Efficiency described above. Then, the composition of the catholyte finally obtained using the gas chromatograph mass spectrometer (GC-MS) (product name: JMS-T100 GCV, manufactured by JEOL Ltd.) was analyzed, and the final toluene concentration in the catholyte was calculated. The above procedure was considered as a single test, and this test was repeated 10 times.

The value obtained by subtracting the calculated toluene concentration from 100 was considered as the overall Faraday efficiency (%). Furthermore, the difference between the overall Faraday efficiency obtained in the initial test and the overall Faraday efficiency of the above-described conventional device was considered as the overall Faraday efficiency improving effect at the initial evaluation. The difference between the overall Faraday efficiency obtained in the 10^{th} test and the overall Faraday efficiency of the conventional device was considered as the overall Faraday efficiency improving effect at the 10^{th} evaluation. Then, the case of the value of each overall Faraday efficiency improving effect being higher than 2% was evaluated as (D, the case of the difference being higher than 0% and 2% or lower was evaluated as o, and the case of the difference being 0% or lower was evaluated as x. o and ⊙ are acceptable evaluations, and x is an unacceptable evaluation. The Faraday efficiency is substantially equal to the organic hydride yield. In the technical field to which the organic hydride producing device 1 belongs, even a slight improvement in the overall Faraday efficiency leads to an increase in the profit, and a 1% improvement is expected to yield a large profit. Furthermore, an improvement of higher than 2% in the overall Faraday efficiency leads to a very large profit in the present technical field.

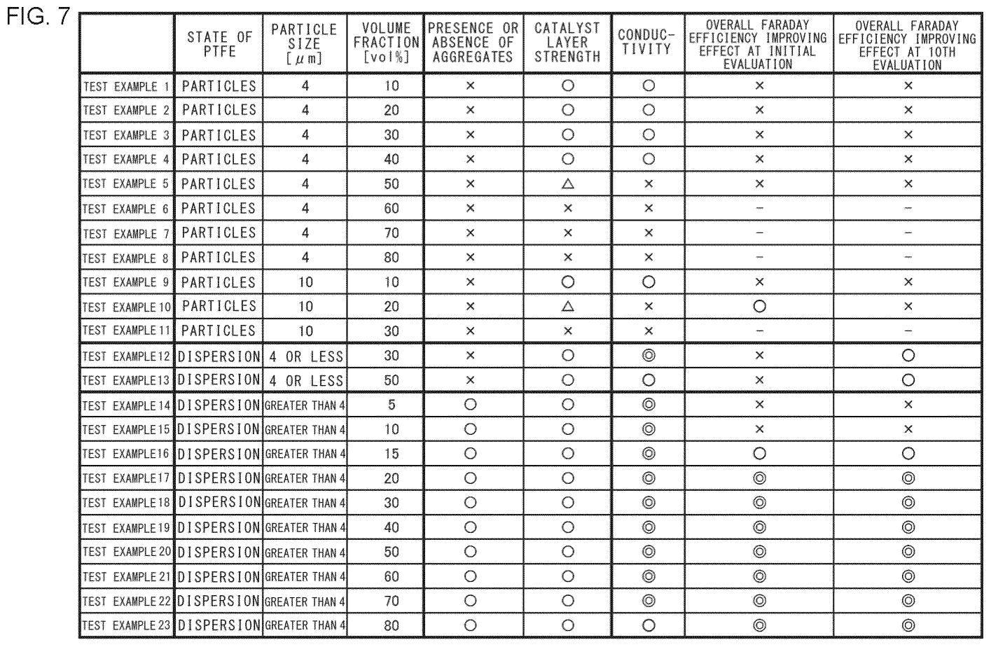

The results of each evaluation are shown in FIG. 7. FIG. 7 is a diagram showing the properties of the cathode catalyst layers and the performances of the organic hydride producing devices in Test Examples 1 to 23. Since PTFE was uniformly dispersed without aggregating in Test Examples 12 and 13, the particle sizes were set to 4 or less for convenience. In Test Examples 14 to 23, the sizes of the aggregates were used as the particle sizes for convenience.

As shown in FIG. 7, the PTFE particles did not aggregate in Test Examples 1 to 11 in which the cathode catalyst inks were prepared by the same procedure as in Comparative Example 3. The PTFE particles also did not aggregate in Test Examples 12 and 13 in which the cathode catalyst inks were prepared by the same procedure as in Comparative Example 2. In Test Examples 6 to 8 which contained the PTFE particles of 4 μm and in which the volume fractions of PTFE were 60 vol % or higher and Test Example 11 which contained the PTFE particles of 10 μm and in which the volume fraction of PTFE was 30 vol %, the cathode catalyst layers collapsed, and thus it was not possible to perform the constant-current electrolysis test.

Although it was possible to perform the constant-current electrolysis test in Test Examples 1 to 5 and 9, the overall Faraday efficiency improving effects were not obtained at any of the initial evaluation and the 10^{th} evaluation. Moreover, the strength of the cathode catalyst layer and the conductivity of the organic hydride producing device in Test Example 5 were lower than those in Test Examples 1 to 4. In Test Example 10, although it was possible to perform the constant-current electrolysis test, and the overall Faraday efficiency improving effect at the initial evaluation was obtained, the overall Faraday efficiency improving effect at the 10^{th} evaluation was not obtained. Furthermore, the strength of the cathode catalyst layer and the conductivity of the organic hydride producing device in Test Example 10 were lower than those in Test Example 9.

The PTFE particles contained in the dispersions aggregated in Test Examples 14 to 23 in which the cathode catalyst inks were prepared by the same procedure as in Example 1. In other words, the non-porous body in the above-described embodiment was formed. In addition, in Test Examples 14 to 23, the cathode catalyst layers had sufficient strength, and the organic hydride producing devices had sufficient conductivity. The overall Faraday efficiency improving effects were not obtained at any of the initial evaluation and the 10^{th} evaluation in Test Examples 14 and 15 in which the volume fractions of PTFE were 10 vol % or lower, whereas the overall Faraday efficiency improving effects were obtained both at the initial evaluation and at the 10^{th} evaluation in Test Examples 16 to 23 in which the volume fractions of PTFE were higher than 10 vol %. From this, it was confirmed that the Faraday efficiency of the organic hydride producing device was improved when the volume fraction of the non-porous body in the cathode catalyst layer was higher than 10 vol %.

It was also confirmed that a more favorable overall Faraday efficiency improving effect was obtained when the volume fraction of PTFE was 20 vol % or higher. Moreover, it was confirmed that more favorable conductivity was obtained when the volume fraction of PTFE was 70 vol % or lower.

The volume fractions in Test Examples 10 and 17 were the same, which were 20 vol %. In addition, the PTFE particles used in Test Example 10 have a size closer to that of the aggregates than the PTFE particles used in Test Examples 1 to 8 do. However, in Test Example 10, the overall Faraday efficiency improving effect at the 10^{th} evaluation was not obtained. On the other hand, the overall Faraday efficiency improving effect at the 10^{th} evaluation was obtained in Test Example 17.

The volume fractions in Test Examples 11 and 18 were the same, which were 30 vol %. In addition, the PTFE particles used in Test Example 11 have a size closer to that of the aggregates than the PTFE particles used in Test Examples 1 to 8 do. However, in Test Example 11, the strength of the cathode catalyst layer was insufficient, and it was not possible to perform the constant-current electrolysis test. On the other hand, in Test Example 18, the cathode catalyst layer had a sufficient strength, and favorable overall Faraday efficiency improving effects were obtained both at the initial evaluation and at the 10^{th} evaluation.

The present inventors contemplated the reason for the occurrence of the performance differences between Test Examples 10 and 17 and between Test Examples 11 and 18. The present inventors found that a difference in PTFE states can lead to the performance difference. That is, in a case where PTFE aggregates during the cathode catalyst layer formation, the aggregated PTFE can be solidified while freely changing shape according to the flow of the surrounding cathode catalyst, catalyst support, or the like. That is, an aggregate can have various shapes. Meanwhile, the PTFE particles themselves do not substantially change shapes. Therefore, the aggregates can exist in the cathode catalyst layer in a state of being in closer contact with the surrounding cathode catalyst, catalyst support, or the like, compared to a single particle having the same size. The strengths of the cathode catalyst layers are considered to be greater in Test Examples 17 and 18 containing the PTFE aggregates than in Test Examples 10 and 11 containing the PTFE particles for this reason. It is considered that, as a consequence, more favorable overall Faraday efficiency improving effects at the 10^{th} evaluation are obtained in Test Examples 17 and 18.

The state in which the aggregates are in close contact with the surrounding cathode catalyst, catalyst support, or the like is considered to be more easily formed by using a dispersion of primary particles. That is, in the dispersion of the primary particles, the primary particles are colloidally dispersed in a state of being contained in micelles of a surfactant. It is considered that, in this case, the primary particles are in a liquid state or a state of being at a glass transition point or higher in the micelles. The primary particles or aggregates thereof can therefore freely change shapes when the micelles of the surfactant are broken, and the primary particles are released. It is considered that, as a result, the degree of freedom in the shapes of the aggregates is further increased, and the aggregates are thus brought into closer contact with the surrounding cathode catalyst, catalyst support, or the like.

1. A cathode catalyst layer that hydrogenates a substance to be hydrogenated with a proton to generate an organic hydride, the cathode catalyst layer comprising:
a cathode catalyst to hydrogenate the substance to be hydrogenated;
a porous catalyst support supporting the cathode catalyst; and a non-porous body including an aggregate of arbitrary primary particles,
wherein a volume fraction of the non-porous body in the cathode catalyst layer is higher than 10 vol % with respect to the volume of the total solid content of the cathode catalyst layer.

2. The cathode catalyst layer according to claim 1,
wherein the primary particles are non-porous.

3. The cathode catalyst layer according to claim wherein the non-porous body is inert to an electrolytic reduction reaction.

4. An organic hydride producing device comprising:
an electrolyte membrane having a first surface and a second surface facing away from each other and transporting a proton;
a cathode provided on the first surface side of the electrolyte membrane and having the cathode catalyst layer according to claim 1; and
an anode provided on the second surface side of the electrolyte membrane and oxidizing water to generate a proton.

5. A method for preparing a cathode catalyst ink used in a cathode catalyst layer that hydrogenates a substance to be hydrogenated with a proton to generate an organic hydride, the method comprising:
preparing a first solution by mixing a cathode catalyst, a porous catalyst support for supporting the cathode catalyst, and a solvent;
preparing a second solution by adding to the first solution a dispersion of arbitrary primary particles, the amount of the dispersion being set so that a volume fraction of a non-porous body in the cathode catalyst layer is higher than 10 vol % with respect to the volume of the total solid content of the cathode catalyst layer; and
forming the non-porous body including an aggregate of the primary particles by aggregating the primary particles in the second solution.
